(19) United States
(12) Patent Application Publication
(10) Pub. No.: US 2026/0312099 A1
(43) Pub. Date: Oct. 8, 2026

(54) Closed-Loop Magnesium Galvanic Power Generation System with Hydrogen Capture

(71) Applicants: Debbie A Maguire, Evansville, IN (US); Jamie Bass, Evansville, IN (US)

(72) Inventors: Debbie A Maguire, Evansville, IN (US); Jamie Bass, Evansville, IN (US)

(73) Assignee: DMAG USA, Evansville, IN (US)

(21) Appl. No.: 19/636,018

(22) Filed: Apr. 1, 2026

Related U.S. Application Data
(60) Provisional application No. 63/781,994, filed on Apr. 2, 2025.

(51) Int. Cl. H01M 8/0606; H01M 4/90; H01M 8/08; H01M 8/083

(52) U.S. Cl. CPC H01M 8/0606; H01M 4/9041; H01M 8/08; H01M 8/083; H01M 2250/10; H01M 2250/30; H01M 2300/0002; H01M 2300/0014

(57) ABSTRACT

A silent, zero-emission on-demand power generator that employs 99.9% pure magnesium anodes and aqueous saline electrolyte in a galvanic cell. A specialized high-performance cathode enables the reaction Mg+2H₂O→Mg(OH)₂+H₂ while generating electrical power and hydrogen. Captured hydrogen provides additional power or revenue. The magnesium hydroxide byproduct is processed on-site through the closed-loop recycling subsystem described in the Detailed Description and shown in FIGS. 1 and 5-7. In preferred embodiments the separated salts are returned to the electrolyte and the recovered water is reused. The dried material undergoes plasma reduction sustained by captured hydrogen and cold-pressing into new anodes in a closed-loop system. The invention is fully scalable for portable, emergency, and grid applications and operates at ambient temperature and pressure with near zero greenhouse gas emissions during use.

### FIELD OF INVENTION

This invention relates to on-demand, silent, zero-greenhouse-gas (GHG) power generation systems that employ electrochemical galvanic reactions. More particularly, the invention pertains to systems using pure magnesium anodes, a specialized high-performance cathode design, a saltwater electrolyte, hydrogen capture for co-generation or sale, and on-site closed-loop recycling of magnesium hydroxide back into usable magnesium anodes via dewatering, salt separation (including hydrocavitation), drying to ≥99.9 % purity and ≥99.9 % dryness, plasma-based or corona-discharge thermal reduction, and cold-pressing anode fabrication.

### BACKGROUND OF THE INVENTION

Traditional power systems, reliant on bulky batteries or fossil fuels, present significant downsides: long recharge/refuel times, fuel logistics challenges, environmental pollution, and noise. Diesel generators, in particular, generate disruptive noise. There's an urgent need for efficient, easily deployable, and environmentally friendly power solutions that operate silently. This invention addresses this gap with a highly efficient, quiet, on-demand power generation system free from fossil fuels, ensuring sustainability by minimizing external consumables through closed-loop material recycling.

### BRIEF SUMMARY OF THE INVENTION

The present invention provides an on-demand power generation system comprising a galvanic cell that instantly produces electricity from pure magnesium anodes (99.9 % purity) and ordinary aqueous saline electrolyte when a load is connected. The system includes a specialized high-performance cathode, hydrogen capture and utilization, and a fully integrated closed-loop magnesium recycling subsystem.

In operation, the galvanic reaction {Mg+2H₂O→Mg(OH)₂+H₂+electricity} generates 3.2 kWh-3.6 kWh of electrical energy per kilogram of magnesium consumed, together with hydrogen gas that is captured for additional power (via fuel cell or generator) or sale as green hydrogen. The magnesium hydroxide byproduct slurry is automatically processed on-site through the closed-loop recycling subsystem (90) described in detail in the Detailed Description and shown in FIG. 1, and 5-7, which includes dewatering and salt removal to ≥99.9 % purity, drying to ≥99.9 % dryness (residual moisture <0.1 %), thermal plasma reduction sustained by captured hydrogen, and cold-pressing (optionally lightly sintered) into new anodes.

In preferred embodiments, the salts separated during recycling are returned directly to the electrolyte reservoir and the recovered water is reused in the galvanic cell, further minimizing external makeup requirements. Although the galvanic reaction is designed to operate at or near ambient temperature, in continuous or high-load operation the cell may experience a modest temperature rise, reaching up to 140° F. (60° C.). In preferred embodiments, integrated temperature sensors and cooling fans (or other thermal-management capabilities) maintain the system within safe operating limits; with hardware designed to tolerate these temperatures.

The entire system operates at ambient temperature and pressure, is completely silent, emits zero GHGs during operation (near zero GHG only during startup), and is scalable across three configurations: (1) small portable/home/business modular units (optional partial recycling), (2) emergency single-use units (no recycling), and (3) large grid-level continuous-feed installations with full closed-loop recycling.

The proposed invention comprises:
Anodes made from 99.9% pure magnesium (Mg).
An aqueous saline electrolyte, typically 3%-5% sodium chloride (NaCl) or potassium chloride (KCl) in water. Alternative electrolyte blends may be used that are formulated to work synergistically with the anode and cathode materials while remaining fully compatible with the closed-loop recycling process. Alternate electrolyte could consist of at least one or a combination of chemicals consisting of Sodium Hydroxide (NaOH), Sodium Hypochlorite (NaOCl), and/or Sodium Carbonate (Na₂CO_{3).}
A novel cathode design comprised of an aluminum mesh plated with autocatalytic process, containing 76%-88% nickel, 6%-12% phosphorus, 4%-8% tungsten, 1%-2% boron, 1%-2% functionalized carbon nanotubes and functionalized nano diamond, followed by a top-coat mixture that may contain functionalized carbon nanotubes, functionalized graphene, functionalized agglomerated spherical-type amorphous carbon, manganese, and/or cobalt, and polyvinyl alcohol (PVA) or Teflon (PTFE) binder. This cathode dramatically enhances reaction kinetics, electroactive surface area, electrical conductivity, and long-term corrosion resistance in the hydrogen and saline environment.
A hydrogen production module to capture and utilize hydrogen gas generated during electrochemical reactions.
A combustion system or fuel cell that converts captured hydrogen into additional power.
An anode recycling process to convert the oxidized byproduct—magnesium hydroxide (Mg(OH)₂) back to reusable anodes. The detailed recycling subsystem is described for magnesium hydroxide, where the processes flow includes dewatering, drying, thermal-reduction, and reforming steps.

When an electrical load is connected to the system, the electrochemical reaction generates electricity. Simultaneously, hydrogen gas is produced and captured, then used in the recycling system, combustion system, and/or fuel cell to generate additional power. The system is designed for rapid deployment and can be scaled based on the power requirements. This system ensures a highly efficient electrochemical reaction for on-demand power generation, enhanced by hydrogen utilization and anode recycling for improved sustainability.

### BRIEF DESCRIPTION OF THE DRAWINGS

FIG. 1 is an overall system view of the entire apparatus and sample useful embodiments. Power generation is accomplished 1) using an electrochemical galvanic reaction, creating DC power generation (FIGS. 2A, 14, 15); and 2) through hydrogen creation to generate DC electricity (83) (using a hydrogen fuel cell (52) and an inverter (81)); and AC electricity (80) using an internal combustion engine (50) (running on hydrogen) coupled to an AC electrical generator (51). The primary use of hydrogen generated (42) by the system will be for consumption by the thermal plasma process (150). The diagram also illustrates two other hydrogen uses, including a hydrogen fill station (49) and hydrogen storage (45). Additionally illustrated is the automatic anode feeding system (19), which allows for extended run time of the system. It is further described in FIG. 2B.

Pictured in the middle of the diagram is the electrolyte filtering system (39) and in the lower right is a block diagram of the recycling system (90) function. As the galvanic cell is operating, the system produces byproducts of hydrogen and an oxidized precipitate (36). The precipitate (36) generated is Magnesium Hydroxide (Mg(OH)₂). A pump (35) continually circulates electrolyte (20, 23, 24) and filters the precipitate (36) using auger (28) and perforated ramp (34), so that filtered electrolyte (24) flows back to the process container (1) through electrolyte supply opening (60). The electrolyte level (21) is maintained so that the anodes (10, 10a) and cathodes (30) are continually submerged.

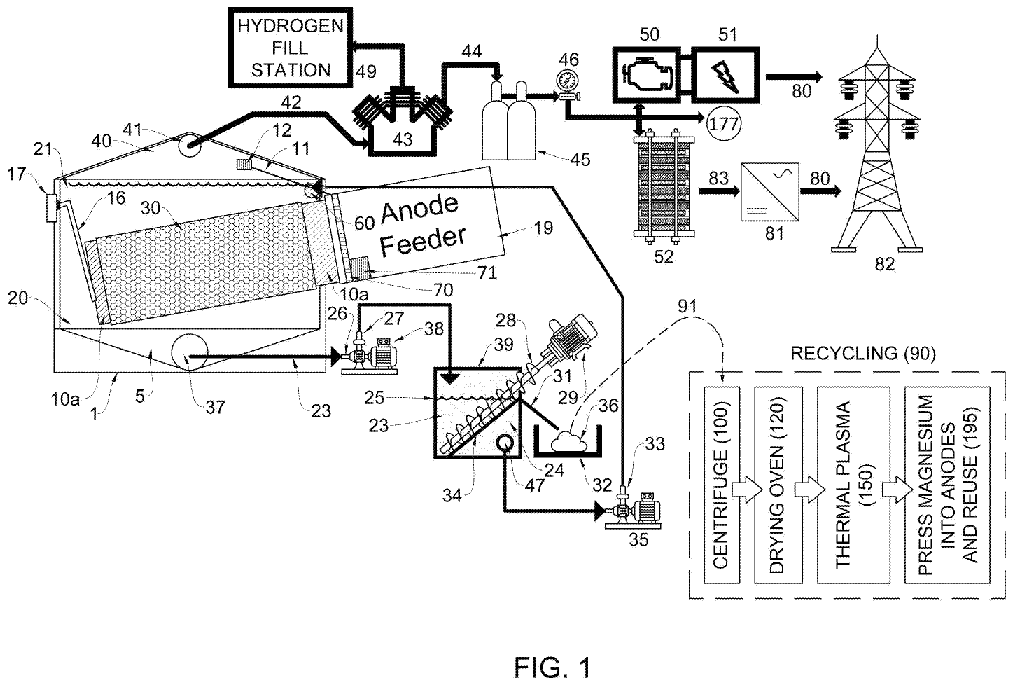

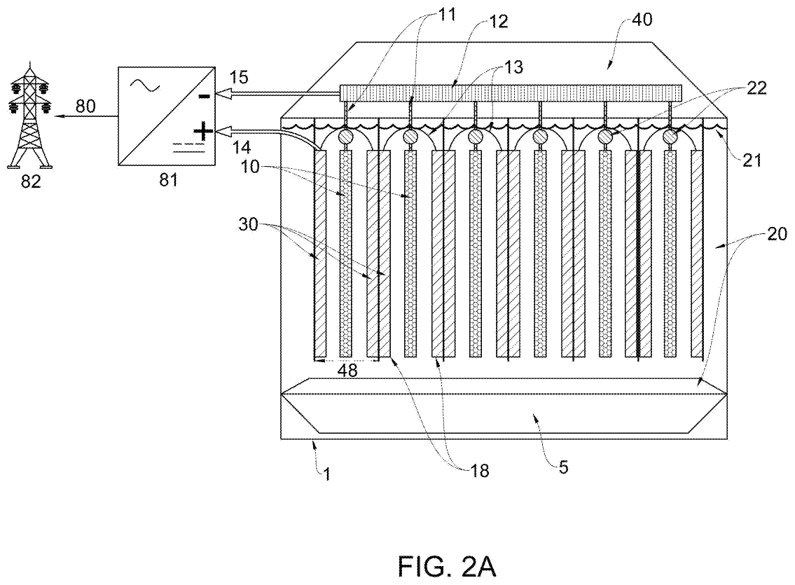

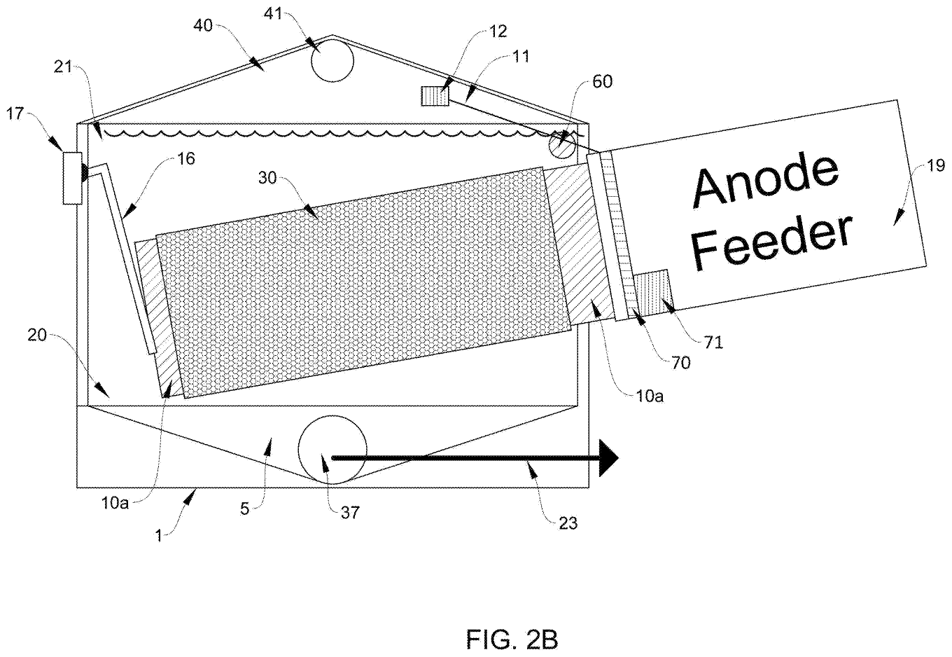

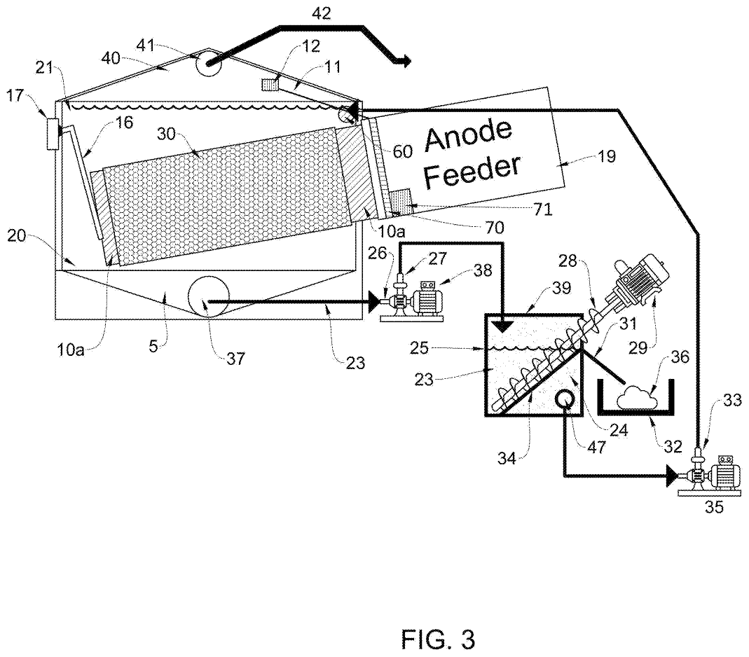

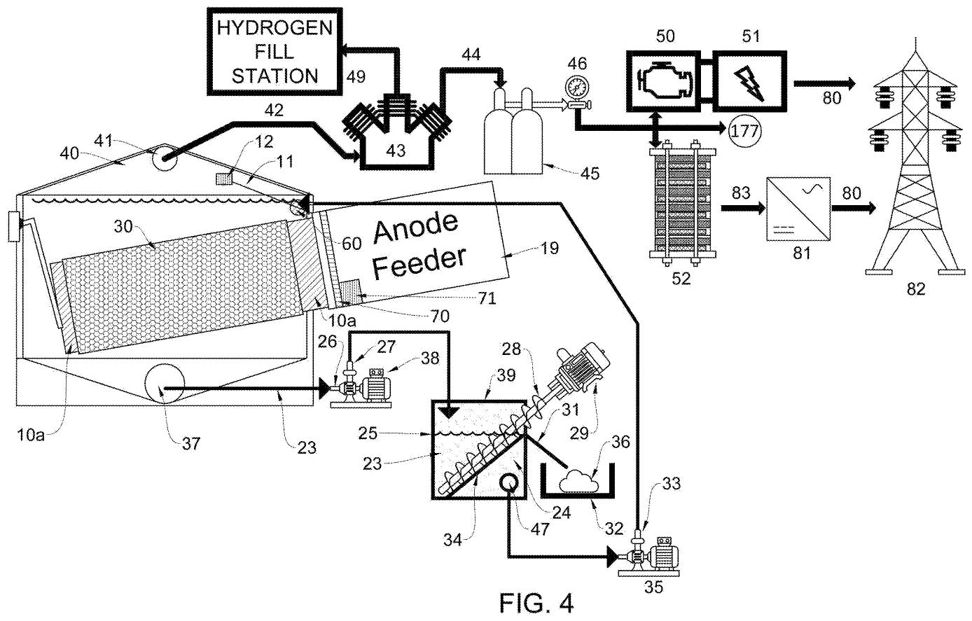

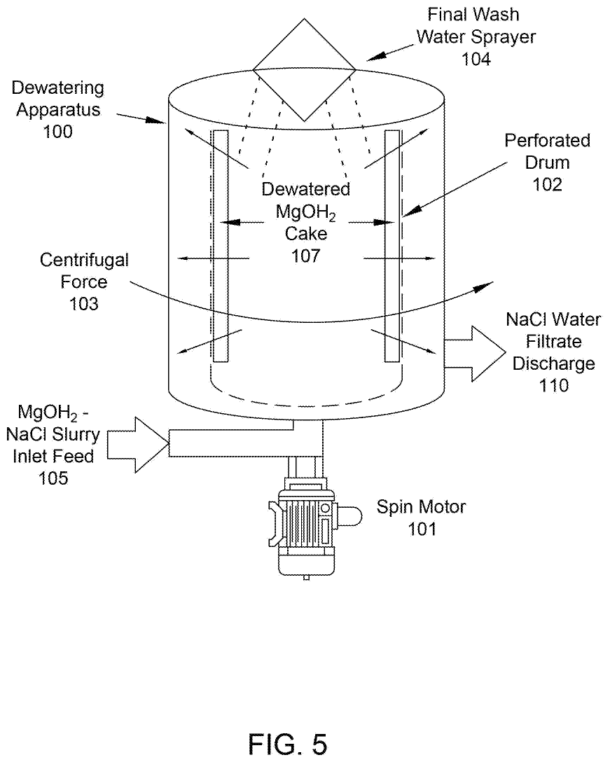

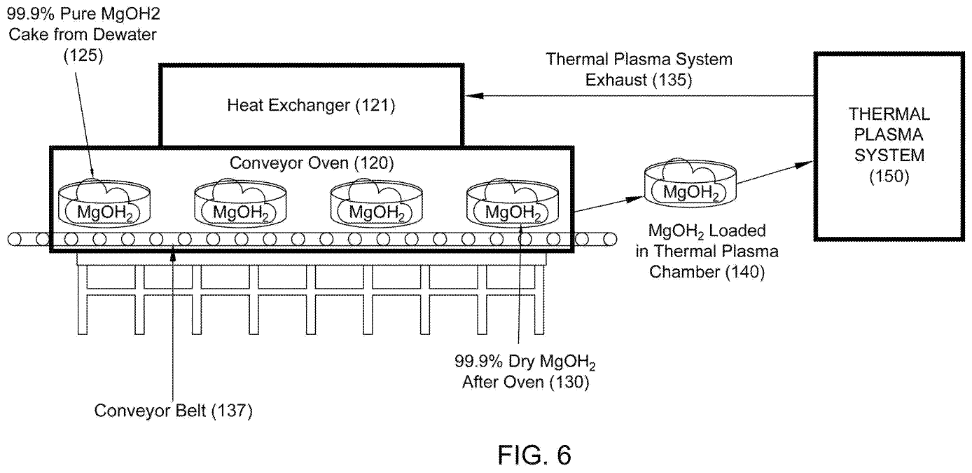

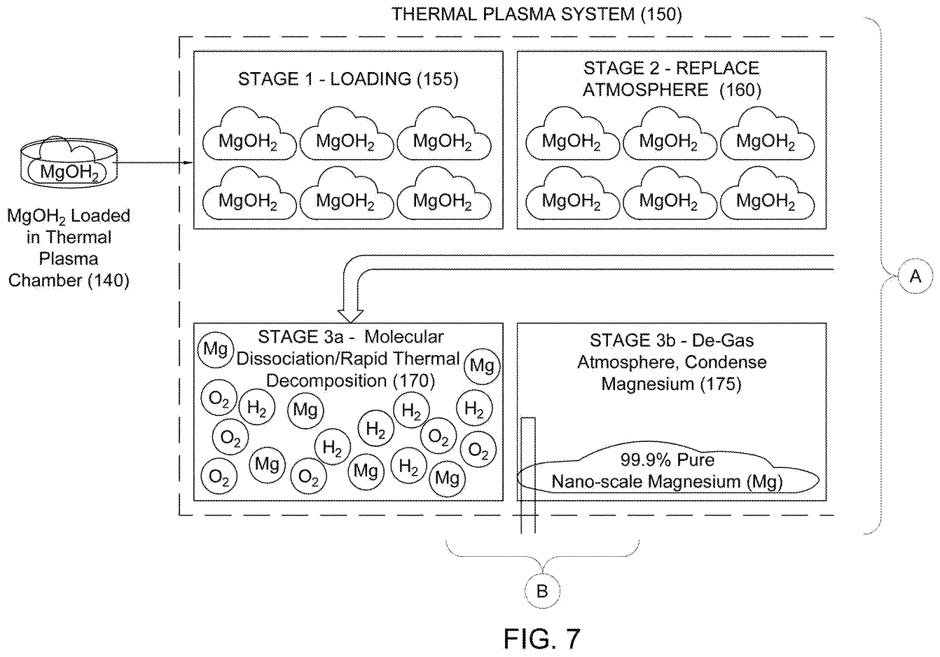

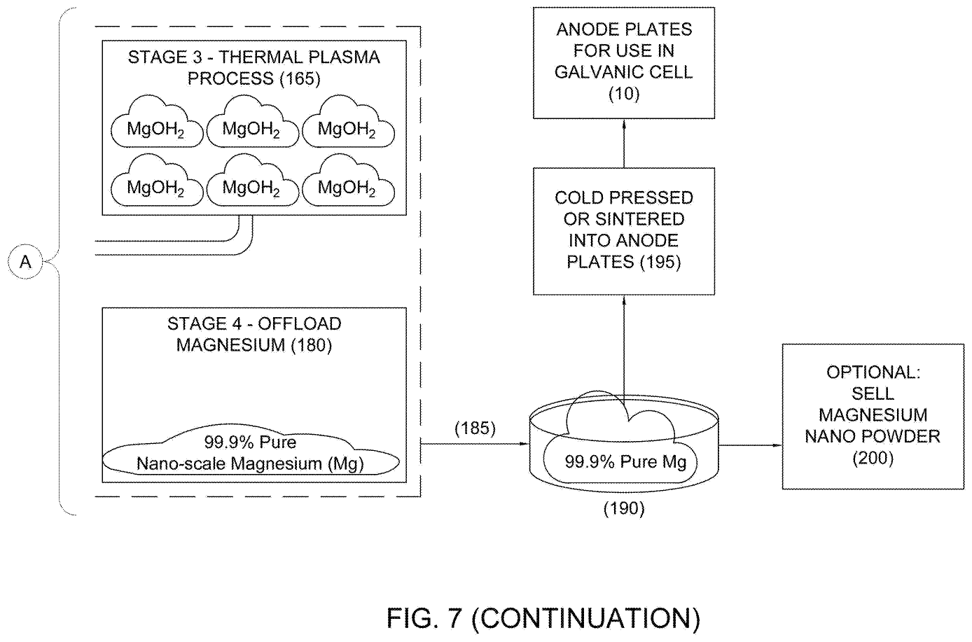

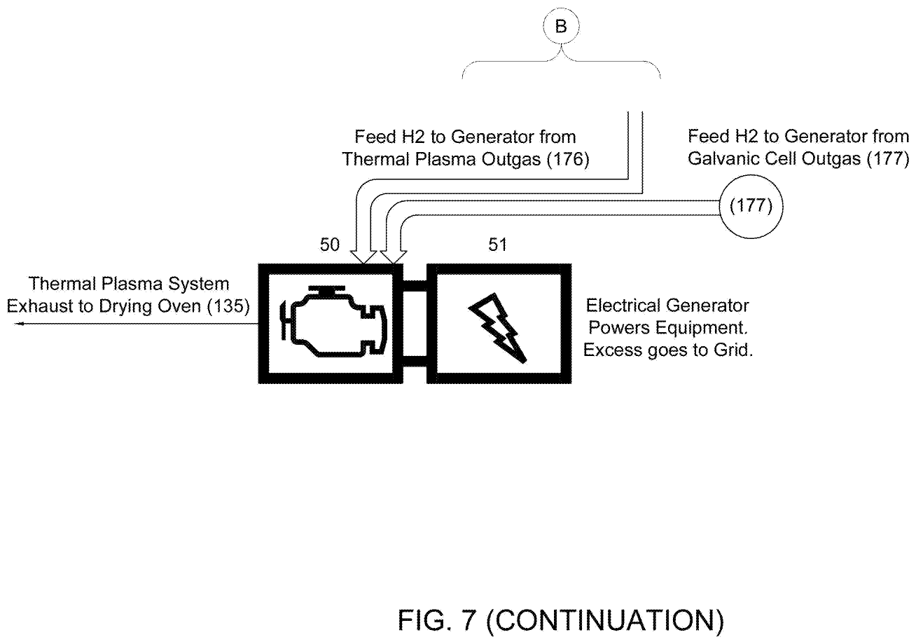

FIG. 2A is a front view of the process container (1). It illustrates the core functions of the electrochemical galvanic reaction power generation apparatus. Anodes (10), connected to a bus bar (12) through wires (11) in the presence of the electrolyte (20), give up electrons to the cathodes (30) to provide useful electrical voltage and current (14, 15). Cathodes are connected in series (13) or parallel for more voltage or current. Hydrogen is formed during the electrochemical process, and is funneled to a hood at the top of the apparatus (40), and hydrogen is extracted from the hood through opening (41). Precipitate from the reaction is forced downward through electrolyte (20) movement, funneled down through bottom angled tray (5), and extracted through opening (FIGS. 1, 37) for the filtering process (FIGS. 1, 39). After filtering, the electrolyte (20) is returned back to the process container via opening (FIGS. 1, 60), and pumped through an opening (22) in each galvanic cell. The flowing electrolyte is designed to keep precipitate from forming on anodes (10) and cathodes (30).

The galvanic reaction occurs in the reaction zone (48), which consists of an anode (10, 10a) and at least one, but optimally two cathodes (30) on each side of the anode, as illustrated. As illustrated in FIG. 1, the electrolyte level (21) is maintained above the anodes (10, 10a) and cathodes (30) to facilitate the full galvanic reaction. Also in this illustration, the unit produces DC voltage and current (14, 15), which is connected to a DC to AC inverter, which provides AC power (80) to the grid (82).

FIG. 2B Illustrates automatic anode feeders (19), which provide a continuous supply of anode material (10, 10a) to the functioning galvanic cell, between the cathodes (30) as described in FIG. 2A. Bus bar connections (11) are attached to the anode feeder (19) rollers (70) to provide electrical connection to the anode (10a). A motor (71) feeds anode material into the galvanic cell until the anode material pushes the striker bar (16) down, which activates switch (17), which interrupts power to the motor (71), thereby stopping the feed of anode material (10, 10a) into the galvanic cell. This process provides a continuous running mode until the anode feeder (19) runs out of material.

FIG. 3 shows the filtering process. Precipitate saturated electrolyte (23) is extracted from the bottom of the process enclosure (1) from opening (37) into the input (26) of pump (38). Pump (38) pressurizes the slurry and pumps it into the filtration processing tank (39). The water level (25) in the filtering tank (39) is kept at a slightly lower level than the precipitate ramp inside the tank, preventing the loss of any unnecessary electrolyte. From there, an auger motor (29) turns an auger (28) to pull solid precipitate (36) up a perforated ramp (34) inside the filtration processing tank (39), which is then deposited on an exit ramp (31) which drops solid precipitate (36) (and a minimal amount of electrolyte) into a container (32). Meanwhile, electrolyte without precipitate (20) flows through the perforated ramp (34), which acts like a filter. The filtered electrolyte (24) is then extracted from opening (47), where it is pumped by pump (35) out opening (33) to the opening (60) in the top of the process container (1). Pressurized filtered electrolyte (24) is then pumped through the process container (1) through the electrolyte feed opening (FIGS. 2A, 22), which flushes small particulate precipitate (36) from the anodes (10, 10a) and cathodes (30), thereby keeping the precipitate (36) from building up and choking out the galvanic reaction. The recycling process (90) is also listed in FIG. 1 in block diagram form and is described in detail in the Detailed Recycling Subsystem section below and in FIGS. 5-7.

FIG. 4 shows some potential uses of the hydrogen generated by the power generation apparatus. Hydrogen generated by the galvanic cell is prevented from escaping by the hood (40), and extracted through opening (41). The hydrogen compressor (43) then compresses low pressure hydrogen into high pressure hydrogen, and stores it in tanks (45). The primary use envisioned for the hydrogen produced will be used for fuel (177) in the thermal plasma process (150) for recycling. It will also be used to provide combustion gas to an internal combustion engine (50), which is coupled to a generator (51) to produce power for the recycling process or transmission to the electrical grid (80). In yet another example, excess hydrogen can be compressed and used to fill containers or vehicles at a hydrogen fill station (49) or provide hydrogen to a hydrogen fuel cell (52) that feeds into an inverter (81), which feeds into the electrical grid (80).

FIG. 5 shows the dewatering process. A slurry of insoluble Mg(OH)₂ and saltwater (105) is introduced to a centrifuge (100), which is used to spin out salt water (NaCl or KCl) (110) from the slurry mix (105). A final stage water sprayer (104) flushes out any remaining saltwater, leaving only the insoluble Mg(OH)₂ cake (107) behind for processing. After the water rinse, the Mg(OH)₂ is at 99.9% purity. The Mg(OH)₂ is removed via automation (not pictured) and introduced into the drying oven (120) as illustrated in FIG. 6 and further processed in the Detailed Recycling Subsystem (90).

FIG. 6 illustrates the oven drying process (120). The Mg(OH)₂ (125) is introduced in batches or continuously to the automated conveyor (137). The drying oven (120) is heated (121) by the exhaust (135) of the Thermal Plasma Process (150) depicted in FIG. 7. The drying oven (120) moves the Mg(OH)₂ (125) material through the oven on the conveyor belt (137), extracting moisture, leaving a 99.9% dry Mg(OH)₂ product (130). The dry Mg(OH)₂ product (130) is then removed from the conveyor belt (137) and transferred (140) into the Thermal Plasma system (150) chamber (155) as described in the Detailed Recycling Subsystem (90).

FIG. 7 is a large diagram that illustrates the Thermal Plasma Process (150). The process is made up of several stages. First, the Mg(OH)₂ material (140) is introduced to the reaction chamber (155) and the chamber is sealed. Second, the reaction chamber atmosphere (160) is replaced with a controlled low-oxygen, argon-purge or vacuum environment. In the third stage (165, see FIG. 7 Continuation (A)), the plasma torches are initiated (first using natural gas to start, then switching to and sustained by hydrogen), which generate temperatures in excess of 1,500° C. (peak temperatures may exceed 5,000° C. locally at the plasma torches). The extraordinary heat of the fourth stage (FIG. 7, Stage 3a) (170) causes rapid thermal decomposition and molecular dissociation of the Mg(OH)₂ in the reaction chamber. In the fifth stage (FIG. 7, Stage 3b) (175), the vaporized magnesium is condensed into a high purity magnesium nano-powder, while oxygen is removed and hydrogen (176) is reused for powering the process (FIG. 7 Continuation (B)). In the sixth stage of the process, Stage 4 (FIG. 7 Continuation (A)) (180), the magnesium nano-powder (190) is removed (185) from the thermal plasma process (150) and cold-formed (or sintered) into anode plates (195) as described in the Detailed Recycling Subsystem (90). Alternatively, the magnesium nano-powder may be sold (200) due to the high value of the nano-structured magnesium powder to industry.

### DETAILED DESCRIPTION

The galvanic process starts occurring as soon as the electrolyte (20) is added to the process container (1) when anodes (10) and cathodes (30) are present and when an external electrical load is connected across the electrodes. The spontaneous galvanic reaction of [Mg(solid)+2H₂O(aqueous)→Mg(OH)₂(solid)+H₂(gaseous)+~3.4 kWh/kg Mg (electricity)] commences immediately, producing direct-current electricity, magnesium hydroxide slurry (hereinafter referred to as the precipitate (36)), and hydrogen gas at the cathode. The cell requires no external voltage, no warmup period, and operates silently at ambient temperature and pressure.

The core of the system is a galvanic cell housed in a process container (FIG. 2A).
1. Anode (10, 10 a): Pure magnesium metal (99.9 % purity) supplied in rod, chip, or cold-pressed powder form. Although Zinc and Aluminum were considered for anode materials, Magnesium was chosen for its superior electrochemical efficacy and is the preferred anode material because it is designed to work with the recycling process.
2. Electrolyte (20, 23, 24): An aqueous saline electrolyte, typically 3%-5% aqueous solution of sodium chloride (NaCl) or potassium chloride (KCl) in water. Alternative electrolyte blends may be used that are formulated to work synergistically with the anode and cathode materials while remaining fully compatible with the closed-loop recycling process.
3. Cathode (30): High-Performance Design: Composed of a novel cathode design comprised of an aluminum mesh plated with autocatalytic process, containing 76%-88% nickel, 6%-12% phosphorus, 4%-8% tungsten, 1%-2% boron, 1%-2% functionalized carbon nanotubes and functionalized nano diamond, followed by a top-coat mixture that may contain functionalized carbon nanotubes, functionalized graphene, functionalized agglomerated spherical-type amorphous carbon, manganese, and/or cobalt, and polyvinyl alcohol (PVA) or Teflon (PTFE) binder. This cathode dramatically enhances reaction kinetics, electroactive surface area, electrical conductivity, and long-term corrosion resistance in the hydrogen and saline environment. The nickel-phosphorus-tungsten-boron-functionalized carbon-nano diamond plating is co-deposited by an autocatalytic plating method; the top-coat mixture is applied as a slurry and cured. The exact layer thicknesses and component ratios are selected to optimize reaction kinetics and corrosion resistance in the saline/hydrogen environment, as demonstrated by the operational performance described herein.
4. Electrolyte filtering (25-29, 31-36, 47)
5. Hydrogen Production capability (40-46, 177): Captures hydrogen gas produced during electrochemical reactions.
6. Hydrogen combustion or Fuel Cell (50-52): Utilizes captured hydrogen to generate additional power through combustion or electrochemical conversion.
7. Electrical Conversion (80): Generation and conversion of electricity.
8. Recycling Process (90): Converts magnesium hydroxide (Mg(OH)₂) back into reusable metal for anodes through:
A. Collection (91): Byproduct precipitate (36) extraction from filtering station (39) and loading into dewatering station
B. Dewatering (100): Extracts salt and water from slurry, provides 99.9% pure MgOH₂.
C. Drying: Conveyor Oven (120) extracts remaining moisture from MgOH₂ cake, provides 99.9% dry MgOH₂.
D. Thermal Plasma Conversion (150): Reduction of oxides to 99.9% pure Magnesium nano-powder metal (190).
D. Anode Fabrication (195): Shaping recovered metals into new anodes (10).

### Impact of Plated Aluminum Mesh in Cathode (30)

The aluminum mesh within the cathodes (30) of this apparatus are novel and specialized. Specific items relating to the plated aluminum mesh are listed below:
Structural Support and Conductivity: Aluminum's lightweight nature offers strong structural support without bulk, ensuring optimal electron flow.
Enhanced Reaction Efficiency: Plating with, nickel, phosphorus, tungsten, boron, functionalized carbon, and functionalized nano diamond enhances electrical conductivity, mechanical strength, and stability.
Increased Surface Area: Mesh coating provides high surface area for electrolyte contact, maximizing reaction sites and energy output. The coating on the aluminum mesh dramatically lowers the hydrogen over-potential, and increases the effective catalytic surface area many fold.
Durability and Longevity: Co-deposited materials withstand hydrogen, embrittlement, and harsh reaction conditions, extending operational life.
Improved Catalytic Activity: A coating on the aluminum mesh facilitates carbon bonding and maximizes hydrogen production and catalytic efficiency.

### Impact of Top Coating on Cathode (30)

The coating on top of the aluminum mesh on the cathodes (30) in this apparatus comprises functionalized carbon nanotubes, functionalized graphene, functionalized agglomerated spherical-type amorphous carbon, manganese (Mn), and/or cobalt (Co), and polyvinyl alcohol (PVA) or Teflon (PTFE) binder. Specific items relating to the cathode (30) top coating are listed below:
Functionalized Carbon Nanotubes (CNTs): Provide high surface area, excellent conductivity, and enhanced mechanical strength.
Functionalized Graphene: Improves conductivity and durability. Provides impermeable barrier that shields the underlying material from corrosion resistance. Also creates bi-functional catalytic sites.
Functionalized Agglomerated Spherical-Type Amorphous Carbon: Offers high conductivity and a uniform surface structure, complementing CNT properties.
Manganese (Mn): Facilitates redox reactions, improves stability, and enhances catalytic performance.
Cobalt (Co): Boosts electrocatalytic properties, especially for oxygen reduction and hydrogen evolution reactions.
Polyvinyl alcohol (PVA) or Teflon (PTFE) binder: Used to bond dissimilar components together.

### Thermal Management

Although the galvanic reaction is designed to operate at or near ambient temperature, in continuous or high-load operation the cell may experience a modest temperature rise, reaching up to 140° F. (60° C.). In preferred embodiments, the system incorporates integrated temperature sensors and cooling fans (or other active or passive thermal-management capabilities) to prevent overheating and maintain optimal operating conditions. The hardware components are specifically designed and rated to safely tolerate these temperatures.

### On Demand Power Generation Advantages

This invention approaches power generation is a unique and special way. A metal-air battery is not in itself novel, however, the cathode design, aluminum mesh plating, and anode recycling processes are novel and unique. The original goal of the invention was to be able to generate power on demand at a low cost with non-toxic components. Key features of the Power On Demand capability are:
On-demand power generation with minimal delay.
High efficiency and energy density.
Lightweight and portable compared to conventional systems.
Reduced environmental impact with reusable and recyclable components.
Additional power from captured hydrogen.
Sustainable operation through anode recycling.

### Process and System Components

The invention described above is an electric generator, utilizing a galvanic reaction (which is an electrochemical process) to create current between the anodes (10) and cathodes (30) in the presence of an electrolyte (20) within the process container (1). As the anodes (10) are consumed, hydrogen and magnesium hydroxide (Mg(OH)₂) are produced. An on-site recycling process (90) recovers the magnesium, generates electricity, and reforms the recycled magnesium back into anodes for reuse in the galvanic cells. The circular recycling nature of this process is novel, and allows for low-cost electricity generation.

The entire operational process is illustrated in FIG. 1. It includes the Process Container (1) and its electrical output (14-15), the hydrogen compression mechanisms (40-46), secondary electrical generation capabilities (50-52), electrical power conversion and transmission (80-83), and the anode recycling process (90-200). FIG. 1 is designed to illustrate the relationships between the various components, and how they work harmoniously to maximize the output of this power generation system.

The process container (1) is illustrated in FIG. 2A as a front view, and FIG. 2B as a side view. Referencing the front view diagram, the air-tight and water-tight process container (1) has anodes (10), cathodes (30), and electrolyte (20) inside. There is at least one cathode (30) for each anode (10), and ideally, one cathode (30) on each side of the anode (10). Each anode (10) and cathode (30) or cathode groupings (18) are separated at the top of the process container (1) within an anode chamber (48) (also known as the reaction zone). The cathodes (30) are typically connected by conductors (13) in a series configuration to achieve higher voltage, or a parallel configuration to achieve higher current. Anodes (10) are connected to the anode bus bar (12) using bus bar connectors (11) either directly (fastened to the anode itself, as in the front view), or, by being electrically connected to the anode feeder (19) metal pinch rollers (70) (see side view), which are electrically connected to the continuously fed anode (10a).

The anode feeder (19) is an air-tight sealed container (so hydrogen can't backfeed or escape) filled with anode material (10) that contains a series of pinch rollers (70) that are electrically connected to the anode bar (12) via conductors (11) as illustrated in FIG. 2B, side view. These pinch rollers (70) feed the continuously fed anode (10a) into the process container (1), under the surface (21) of the electrolyte (20). The anode feeder (19) pinch rollers (70) have a small motor (71) connected to them that feeds the anode in until it hits the anode stop bar (16), which activates the anode stop limit switch (17), which stops the anode feeder motor (71) from pushing more anode into the anode chamber (48) (reaction zone). When the anode is consumed by the reaction, the anode stop bar (16) retracts and releases the anode stop limit switch (17), which feeds more anode (10a) into the anode chamber (48), thus accomplishing a continuous feed until the continuously fed anode (10a) runs out.

When the device is in operation, voltage and current are measured at the output of the device at terminals (14) and (15), with the negative charge being measured at terminal (15) connected to the anodes (10), and the positive charge being measured at terminal (14) connected to the cathodes (30) arranged in series (13) in this particular embodiment. As an alternative option to direct current (DC) output, a power inverter (81) is illustrated for converting direct current (14, 15) to alternating current (AC) (80), with the AC output (80) of the inverter (81) being connected to an AC load, in this embodiment the electrical grid (82), but it could be any AC electrical load.

The anodes (10) lose electrons, which flow to the cathode(s) (30) via the electrolyte (20), which creates electrical voltage and current which can be applied to a direct current electrical load at terminals (14) and (15).

As stated in the summary above, the galvanic reaction is an oxidizing reaction. If the anode used is Magnesium, the reaction creates Magnesium Hydroxide (Mg(OH)₂). All oxidized byproduct waste material from the reaction build up as a white sludge (36) within the electrolyte (20). The white sludge (36) is an undesirable byproduct for the efficient function of the galvanic reaction because it will build up on the anodes (10) and cathodes (30), causing the reaction to become increasingly less efficient. Circulation pumps (35 and 38) circulate the electrolyte (20, 23, and 24) through a filter (34) and removal system (39) to extract the insoluble precipitate byproduct (36).

FIG. 3 illustrates the removal of the white precipitate sludge (36) Mg(OH)₂ by a plurality of devices. First, the contaminated electrolyte (23) is removed from the bottom of the process container (1) through opening (37). It flows into the intake pipe (26) of pump (38), and pump (38) pressurizes the contaminated electrolyte (23) and pushes it to the output pipe (27) where it flows into the filtration tank (39). The filtration tank (39) has multiple features uniquely suited to the removal of the white precipitate sludge (36) from the contaminated electrolyte (23). First, larger particulates of white sludge (36) are pulled up the slide (34) through mechanical action of the auger (28) driven by the auger motor (29). The white sludge (36) that is removed is deposited by ramp (31) into bin (32), where it can be later reconstituted back into anodes again through a recycling process (90).

The filtration tank (39) contaminated electrolyte level (25) in FIG. 3 is maintained so that the level is at or below the white sludge (36) ramp (31). This minimizes the amount of contaminated electrolyte (23) lost in the bin (32). Another feature of the filtration tank (39) ramp (34) is a fine mesh screen, which functions as a filter and allows liquid to flow through the screen while mostly blocking white sludge (36). The filtered electrolyte (24) flows to the intake (47) of pump (35), and the pressurized filtered electrolyte (24) is pumped out (33) of pump (35), which flows back to the top of the process container (1) through opening (60). Electrolyte fill opening (60) in the process container (1) is internally plumbed to each anode chamber hole (22), and filtered electrolyte (24) then flows directly onto each anode (10) and cathode (30) in each chamber (48), flushing sludge from the system from top to bottom. It should be noted that even though there are multiple anode chambers (48) separated at the top of the process container (1), the anode chambers (48) are open at the bottom of the process container (1) where the unfiltered (contaminated with precipitate) electrolyte (23) flows out of the process container (1).

In addition to electrical output (14, 15) of the apparatus, the galvanic reaction provides an uncompressed hydrogen output (42) as an additional product of the reaction. As mentioned earlier, the process container (1) is not only water-tight, it is air-tight. The process container (1) is air tight to capture hydrogen produced in the galvanic reaction. FIG. 4 illustrates the hydrogen hood (40), which captures hydrogen produced by the reaction. The hydrogen produced by the reaction is lighter than air, and floats to the top of the hood (40), where it is extracted from the hydrogen opening (41). The uncompressed hydrogen (42) is pulled into the hydrogen compressor (43), where it is then compressed. The primary output (44) will feed hydrogen to the thermal plasma recycling process (177). Another output hydrogen output is from the thermal plasma system, and is envisioned as another source feeding (176) the combustion generator (50). Another use for the hydrogen produced is for feeding the compressed hydrogen storage (45), whereas yet another output may be used to go to a hydrogen fill station (49). These are only a few examples of the myriad of potential uses for the hydrogen, and should not be considered an exhaustive representation.

As illustrated FIG. 4, compressed hydrogen from the hydrogen storage (45) is routed through a pressure regulator valve (46), and in this example embodiment is shown feeding the thermal plasma system (177), and the thermal plasma system (when operating at capacity) feeding (176) an internal combustion engine (50) and also a hydrogen proton-exchange-membrane (PEM) fuel cell (52). The hydrogen powered internal combustion engine (50) in this embodiment is connected to an electrical generator (51), with the intended result being to generate alternating current electricity (80) to send to the electrical grid (82) or back to the recycling process (90). Alternatively, the hydrogen fuel cell (52) takes hydrogen and converts it to direct current (83), which in this embodiment is fed to a power inverter (81) that converts the DC electricity (83) to AC electricity (80), which is sent to the electrical grid (82). Another option is bottling/storage of excess hydrogen for sale as zero-emission “green” hydrogen as used in hydrogen fill stations (49). As stated earlier, these are merely representative examples of the myriad of possibilities of extracting electricity or usable work from hydrogen.

### Detailed Recycling Subsystem (90)

As discussed earlier, the galvanic reaction creates a byproduct precipitate (36) (magnesium hydroxide) that must be processed for continued efficient operation. In FIG. 1, Mg(OH)₂ sludge (36) is fed (91) into the recycling process (90). The process illustrated focuses on Magnesium Hydroxide (Mg(OH)₂), which is the byproduct of the galvanic reaction of magnesium anodes (10) with the high-performance cathodes (30) in the presence of electrolyte (20). The Mg(OH)₂ slurry produced by the galvanic reaction is continuously or batch routed to the recycling module.

The first recycling stage, as illustrated in FIG. 5, is comprised of dewatering of the slurry. Dewatering consists of separating the salt water (>99 % removal of residual NaCl or KCl), which is optimally achieved by centrifuge (100) that uses a motor (101) to spin a perforated drum (102), which causes centrifugal force (103) to force salt water (filtrate) discharge (110) out of the process. The final stage of dewatering is accomplished by water wash sprayers (104), which flush out any remaining salt water and leave the insoluble Mg(OH)₂ behind as a 99.9% pure solid in cake form (107). Other mechanisms such as filtration, sedimentation, or hydrocavitation (not illustrated) may also be used as an alternative salt-separation technique. In preferred embodiments, the separated salts (NaCl or KCl) (110) are returned directly to the electrolyte reservoir and the recovered water is reused in the galvanic cell, further preserving the electrolyte with minimal external makeup.

A conveyor oven, as illustrated in FIG. 6, is heated by the recovered exhaust waste heat (135) of the thermal plasma system (150). This phase of the recycling process achieves drying of 99.9% pure magnesium hydroxide powder to yield 99.9 % dryness (residual moisture <0.1 % by weight). This high-purity, high-dryness, essentially anhydrous powder is the required feedstock for the thermal plasma reduction system (150). Dewatered magnesium hydroxide is placed in a container through manual or preferably using automation onto a conveyor belt that moves through the heated conveyor oven (120). The heat exchanger (121) supplies all the heat necessary to dry the Mg(OH)₂ sufficiently to achieve a 99.9% dryness (130). Once the Mg(OH)₂ completes the drying cycle, the containers are loaded (140) into the thermal plasma system chamber (155).

FIG. 7 illustrates the thermal plasma system (150) process. The 99.9% pure and 99.9% dry Mg(OH)₂ is loaded (140) into the thermal plasma chamber (155). The chamber is equipped with multiple plasma torches or corona discharge apparatuses. The 99.9 % pure/99.9 % dry Mg(OH)₂ is continuously fed into the chamber. The plasma torches or corona discharge apparatus are initiated with natural gas and thereafter sustained by captured hydrogen (177) under controlled low-oxygen, argon-purge, or vacuum conditions (160), generating temperatures in excess of 1,500° C. (peak temperatures may exceed 5,000° C. locally at the plasma torches)(165). Rapid thermal decomposition (170) produces magnesium metal vapor that is condensed and collected (175) as high-purity powder, along with recoverable thermal energy (135) and hydrogen (176). All process parameters are monitored and controlled by an integrated automation system.

The recovered magnesium powder (190) is formed on-site or on-campus into dense anode (195) shapes (rods, plates, or pellets) by uniaxial or cold-isostatic pressing at 200-400 MPa. An optional light sintering step (400-500° C. for 30-60 minutes in an inert atmosphere) may be applied to close residual porosity and enhance mechanical integrity.

Optionally, nano-scale high purity magnesium powder (200) may be sold at a premium, as this high purity and reactive metal is highly desirable in industries such as energetics and industrial chemical processes.

### Scalable System Configurations

Embodiments of the system and methods described above can be (but are not limited to) implemented in the following configurations:
Portable/Home/Small-Business Units: Compact, modular galvanic cells with a few dozen anodes and the specialized high-performance cathodes, with anode recycling done by a 3rd party (i.e. precipitate (36) is collected and shipped to a central recycling facility).
Emergency Power Units: Single-use configuration (no recycling required) providing instant, silent backup power for outages or remote sites, with the same galvanic cell and cathode construction but without the recycling subsystem (90).
Grid-Level/Industrial Installations: Continuous-feed cells with full closed-loop recycling, hydrogen co-generation, and integration with the electrical grid or large facilities. Full operations and recycling integration is on-site/on-campus.

### Working Example 1—Pilot-Scale Energy and Mass Balance for Thermal Reduction

In one working embodiment, a pilot-scale plasma/corona reduction module processes a 10 kg batch of dry Mg(OH)₂ (99.9% purity, molar quantity 171.3 moles). The primary galvanic reaction supplies 0.35 kg of hydrogen gas. Supporting natural gas (CH₄) is added at 0.68 kg to complete a mixed process gas total of 1.03 kg. The reactor operates at an average temperature >1,500 ° C. under a reducer-rich atmosphere. Plasma energy intensity is 2 kWh/kg, resulting in 20 kWh actual electrical consumption for the batch (theoretical endothermic demand ≈34 kWh). The captured hydrogen serves as both a chemical reductant/process gas and a thermal sustainment source after initial natural-gas ignition. Scaled pilot components include a 10-liter reaction chamber, 20 kW installed plasma power, 2 kW quench compressor, and 1 kW selective recovery system. This example demonstrates practical operability of the closed-loop recycling subsystem is configured such that, when operated in accordance with the pilot-scale parameters set forth in the Working Example, the subsystem recovers the anode metal with a material loss of no more than 5 % per full cycle and enables a lifetime electrical output of at least 67 kWh per kilogram of initial magnesium invested.

Parasitic loads from electrolyte circulation pumps, auger motors, anode feeders, hydrogen compressor, and plasma power supply are offset by the electrical output of the galvanic cells plus the secondary hydrogen combustion generator or fuel cell. In the pilot embodiment the net system output remains positive, enabling the claimed lifetime electrical output exceeding 67 kWh per kilogram of initial magnesium invested.

1. A power generation system comprising at least one anode comprising 99.9% pure magnesium; an aqueous saline electrolyte in contact with the anode; a cathode comprising an aluminum mesh substrate plated by an autocatalytic (electroless) process to form a co-deposit containing 76-88 % nickel, 6-12 % phosphorus, 4-8 % tungsten, 1-2 % boron, and 1-2 % functionalized carbon nanotubes and functionalized nano-diamonds, the cathode further comprising a top-coat layer comprising functionalized carbon nanotubes, functionalized graphene, functionalized agglomerated spherical-type amorphous carbon, manganese and/or cobalt, and a polyvinyl alcohol (PVA) or Teflon (PTFE) binder; a process container configured to contain the anode, cathode, and electrolyte and to capture hydrogen gas produced by the galvanic reaction; an automatic anode feeder configured to continuously supply anode material into the electrolyte while maintaining electrical connection; an electrolyte filtering subsystem comprising a pump, a filtration tank having a perforated ramp and auger, and return plumbing that flushes filtered electrolyte directly onto the anodes and cathodes to prevent precipitate buildup; a closed-loop recycling subsystem configured to convert oxidized byproduct precipitate from the galvanic reaction back into new anode material, wherein the recycling subsystem recovers the anode metal with a material loss of no more than 5 % per full cycle and the captured hydrogen gas produced by the galvanic reaction is supplied as the primary plasma sustainment fuel, enabling a lifetime electrical output exceeding 67 kWh per kilogram of initial magnesium invested; wherein the thermal plasma reduction is performed in a controlled low-oxygen, argon-purge or vacuum environment using plasma torches or corona discharge initiated with natural gas and thereafter sustained by the captured hydrogen gas.

2. The power generation system of claim 1, wherein the galvanic reaction produces 3.2 kWh-3.6 kWh of electrical energy per kilogram of magnesium consumed.

3. The power generation system of claim 1, wherein the automatic anode feeder comprises pinch rollers electrically connected to an anode bus bar, a motor, a striker bar, and a limit switch that automatically stops and resumes feeding of anode material to maintain continuous operation of the galvanic reaction.

4. The power generation system of claim 3, further comprising a hydrogen capture module including a hood, compressor, and storage tanks, wherein captured hydrogen is supplied to at least one of: (i) the recycling subsystem as a plasma sustainment fuel, (ii) a combustion engine coupled to a generator, (iii) a hydrogen fuel cell, or (iv) a hydrogen fill station.

5. The power generation system of claim 1, wherein the recycling subsystem comprises, in sequence: (a) centrifugal dewatering of the precipitate utilizing filtration, sedimentation, or hydro-cavitation to achieve at least 99.9% purity; (b) conveyor-oven drying utilizing waste heat from the thermal plasma step to achieve at least 99.9% dryness (residual moisture <0.1% by weight); (c) thermal plasma reduction in a controlled low-oxygen, argon-purge, or vacuum environment using plasma torches initiated with natural gas and thereafter sustained by captured hydrogen gas at an average temperature greater than 1,500° C. (with local peak temperatures exceeding 5,000° C.); and (d) cold-pressing or sintering of the resulting high-purity magnesium nano-powder into new anodes.

6. The power generation system of claim 5, wherein the recycling subsystem recovers the anode metal with a material loss of no more than 5% per full cycle.

7. The power generation system of claim 5, further comprising an inverter configured to convert direct-current output from the galvanic reaction and/or hydrogen fuel cell into alternating-current power for grid connection or local load.

8. A method for on-demand generation of electrical power, comprising the steps of: (a) contacting at least one anode comprised of magnesium with an aqueous saline electrolyte in the presence of a cathode comprising an aluminum mesh substrate plated by an autocatalytic (electroless) process to form a co-deposit containing 76-88% nickel, 6-12% phosphorus, 4-8% tungsten, 1-2% boron, and 1-2% functionalized carbon nanotubes and functionalized nano-diamonds, the cathode further comprising a top-coat layer comprising functionalized carbon nanotubes, functionalized graphene, functionalized agglomerated spherical-type amorphous carbon, manganese and/or cobalt, and a polyvinyl alcohol (PVA) or Teflon (PTFE) binder, thereby initiating a galvanic reaction that produces electricity, hydrogen gas, and an oxidized precipitate; (b) continuously feeding fresh anode material into the electrolyte via an automatic feeder while capturing the hydrogen gas; (c) filtering and recirculating the electrolyte through a filtration tank having a perforated ramp and auger, and flushing filtered electrolyte directly onto the anodes and cathodes to prevent precipitate buildup; (d) capturing and utilizing the hydrogen gas in at least one of a recycling process, combustion generator, fuel cell, or storage, wherein the captured hydrogen gas is supplied as the primary plasma sustainment fuel in the recycling process; and (e) recycling the oxidized precipitate through dewatering to ≥99.9% purity, drying to ≥99.9% dryness using waste heat, thermal plasma reduction sustained by captured hydrogen, and reforming the resulting metal powder into new anodes for reuse in step (a), wherein the recycling recovers the anode metal with no more than 5% material loss per cycle, enabling a lifetime electrical output exceeding 67 kWh per kilogram of initial magnesium invested.

9. The method of claim 8, wherein the thermal plasma reduction step is performed in a controlled low-oxygen environment at an average temperature greater than 1,500° C. with local peaks greater than 5,000° C. at the plasma torches.

10. The method of claim 9, wherein the recycling step recovers the anode metal with no more than 5% material loss per cycle.

11. The method of claim 9, further comprising supplying at least a portion of the captured hydrogen to sustain the plasma torches after initial natural-gas ignition.

12. The method of claim 9, further comprising converting at least a portion of the electricity produced by the galvanic reaction or a hydrogen fuel cell into alternating current via an inverter for grid or load use.

13. The power generation system of claim 1, wherein the system is configured as a portable or modular unit for residential, small-business, or emergency use.

14. The method of claim 8, wherein the method is performed in a portable or modular unit for residential, small-business, or emergency use.

15. The power generation system of claim 1, wherein the system is configured as a single-use emergency power unit without on-site recycling of the magnesium hydroxide.

16. The method of claim 8, wherein the method is performed as a single-use emergency power unit without on-site recycling of the magnesium hydroxide.

17. The power generation system of claim 1, wherein the system is configured as a large-scale grid-connected installation with continuous-feed cells, full closed-loop recycling, hydrogen co-generation, and integration with the electrical grid or large facilities, with all operations and recycling performed on-site or on-campus.

18. The method of claim 8, wherein the method is performed in a large-scale grid-connected installation with continuous-feed cells, full closed-loop recycling, hydrogen co-generation, and integration with the electrical grid or large facilities, with all operations and recycling performed on-site or on-campus.

19. The power generation system of claim 1, wherein the aqueous saline electrolyte comprises 3%-5% sodium chloride (NaCl) or potassium chloride (KCl) in water.

20. The power generation system of claim 1, wherein the aqueous saline electrolyte comprises at least one or a combination of sodium hydroxide (NaOH), sodium hypochlorite (NaOCl), and/or sodium carbonate (Na₂CO₃).

21. The method of claim 8, wherein the dewatering step utilizes a centrifuge with a perforated drum and final water-spray rinse to separate and return NaCl or KCl salts directly to the electrolyte reservoir.
